(19) United States
(12) Patent Application Publication
(10) Pub. No.: US 2010/0299108 A1
(43) Pub. Date: Nov. 25, 2010

(54) METHOD FOR DESIGNING THE WALL THICKNESS OF COMPONENTS AND COMPONENT

(75) Inventors: Stefan Glaser, Schifferstadt (DE); Andreas Wuest, Zwingenberg (DE); Bernhard Aumer, Fischbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/740,915

(22) PCT Filed: Oct. 15, 2008
(86) PCT No.: PCT/EP08/63829

§ 371 Date: Aug. 10, 2010

(30) Foreign Application Priority Data
Oct. 30, 2007 (EP) 07119639.8

(51) Int. Cl. G06F 17/50; B32B 33/00; G06G 7/48

(52) U.S. Cl. 703/1; 428/332; 703/6

(57) ABSTRACT

The invention relates to a method for designing the wall thickness of components that are permanently subjected to static and/or dynamic loading, the components being made of a fiber reinforced polymer material. In a first step, the orientation of the fibers in the fiber reinforced plastic and the position of the weld lines in the component are determined by a first simulation calculation. A degree of utilization of the strength of the component is calculated by a second simulation calculation. The wall thickness of the component is adapted to the result of the second simulation calculation, and the previous steps are repeated if a change of the wall thickness has been carried out. The invention also relates to a component of a fiber reinforced polymer material that has a wall thickness designed by the method according to the invention.

### DESCRIPTION

The invention relates to a method for designing the wall thickness of components that are permanently subjected to static and/or dynamic loading, the components being produced from a fiber reinforced polymer material. The invention also relates to a component of a fiber reinforced polymer material that is permanently subjected to static and/or dynamic loading.

Supports are generally subjected to a continuous static force by any device that is held by the support. If the device that is held by the support is an engine, it is also possible, for example, that vibrations are transferred to the support. As a result, the support is additionally permanently subjected to dynamic loading. Such supports are, for example, engine supports in motor vehicles.

The engine supports in motor vehicles are usually made of a metallic material. The metallic material makes it possible to realize low wall thicknesses on account of the great strength of the metal. However, a disadvantage of metallic supports is their great weight.

Alternatively, it is known, for example from DE-A 103 29 461, to form an engine support from a fiber reinforced plastic. Carbon fiber reinforced plastics are considered to be particularly suitable. To achieve adequate strength with respect to the static and dynamic loads that act on the support, however, it is necessary to form the support with a great wall thickness. Generally, a constant wall thickness is set for the support. The lower strength of the reinforced plastics in comparison with metals has the effect that the wall thickness must be greater than in the case of comparable supports of metallic materials. This results in an increased space requirement when the carbon fiber reinforced engine supports are installed.

The design of wall thicknesses for one-off, sudden loading is known, for example, from S. Glaser, A. Wüst, “Modellierung am Computer” [computer modeling], Kunststoffe 3/2005, pages 132-136. This involves simulating the behavior of supports of fiber reinforced polymer material in a collision accident of a motor vehicle. The simulation makes it possible to determine the design of the wall thickness of loaded parts that is optimized for the crash behavior of the motor vehicle. Therefore, regions that are subjected to greater loading are made with a greater wall thickness and parts that are subjected to less loading are made with a lower wall thickness. The adaptation of the wall thickness to the loading of the component allows a component that is optimized in terms of the installation space to be produced.

However, a correspondingly designed support has only adequate crash resistance. Sufficient strength in terms of static and/or dynamic loading that is applied by the engine resting on the support is not taken into account. It is therefore an object of the present invention to provide a method by which the wall thickness of a support that is permanently subjected to static and/or dynamic loading is adapted to the loading applied to the support in order to achieve sufficient strength of the support.

The object is achieved by a method for designing the wall thickness of components that are permanently subjected to static and/or dynamic loading, the components being made of a fiber reinforced polymer material, comprising the following steps:

(a) determining the orientation of the fibers in the fiber reinforced plastic and of the weld lines in the component by a first simulation calculation,

(b) calculating a degree of utilization of the strength of the component by a second simulation calculation,

(c) adapting the component geometry and/or the position of the at least one gating point of the component to the result of the second simulation calculation, a reduction of the wall thickness taking place if the degree of utilization exceeds a predetermined upper limit value and an increase of the wall thickness taking place if the degree of utilization falls below a predetermined lower limit value,

(d) repeating steps (a) to (c) if a change of the component geometry and/or of the position of the at least one gating point has been carried out in step (c).

Polymers have a pronounced nonlinear stress-strain behavior under high loads. This behavior is generally strongly dependent on the strain rate. Therefore, very much higher yield stresses are achieved at great strain rates than under slow loading. Moreover, the yield stress for many polymers is much higher in the compressive range than in the tensile range. In addition, under great strains there are persistent inelastic elements, which no longer relax completely when the loading is relieved. Plastics therefore display very complex, nonlinear/viscoplastic behavior.

Fiber reinforced thermoplastic materials display better mechanical properties than unreinforced thermoplastics and, for this reason, are of interest for load-bearing structures. However, the mechanical properties of the fiber reinforced thermoplastic materials are no longer isotropic, since the processing process, in particular injection molding, has the effect that the fibers are oriented by the flow. This leads to anisotropic, i.e. directionally dependent, mechanical behavior of the rigidity, yield stress and elongation at break of the material.

As a difference from the crash simulation that is known from the prior art, in which great loads occur but generally take place with a high strain rate on account of the speed at which the crash happens, in the case of components that are permanently subjected to static and/or dynamic loading it is also necessary to take the constant loading into account. A sudden great strain rate does not occur. This also has the effect that the yield stress in terms of the permanent static and/or dynamic loading, as occurs in the case of loaded components, is very much lower, and consequently even slight loading can lead to failure of the component. This behavior is taken into account by the method according to the invention for designing the wall thickness.

The method according to the invention allows the component geometry to be adapted to the loading occurring locally. For the purposes of the present invention, component geometry is understood, for example, as meaning the wall thickness, rib height and form of the component. For example, regions of the component in which low loading occurs are made with a smaller wall thickness and regions of the component that are subjected to higher loading are made with a greater wall thickness. By this design, on the one hand material, and consequently weight, can be saved, on the other hand a reduction of the required installation space is possible as a result of the fact that the wall thickness of the component is adapted to the corresponding local loading.

The determination of the orientation of the fibers and the weld lines in step (a) preferably takes place by simulation of the production process of the component. Apart from the orientation of the fibers and the weld lines, variables that are likewise involved in the process, such as pressure distribution and temperature, are determined by the simulation of the production process.

The orientation distribution density of the fibers in the component is generally inhomogeneous and depends on the production process. For an injection molding process, the process that is also generally used to produce components from fiber reinforced plastic, the orientation distribution density of the fibers is calculated from the data of the simulation of the injection molding process by means of numerical integration from the extended Jeffery equation, as described for example in G. B. Jeffery, “The motion of ellipsoidal particles immersed in a viscous fluid”, Proc. of the Royal Society of London, Series A, 1922, pages 161 to 179. This gives a fiber orientation tensor for every location in the component, from which there follows an approximation for the orientation distribution density.

To calculate the degree of utilization of the strength of the component by the second simulation calculation in step (b), it is necessary to describe the fiber reinforced polymer material numerically. The numerical description takes place by means of a material which is based on a viscoplastic theorem for the polymer material and on an elastic model for the fibers, which is combined with a micromechanical model for the description of the material composite, i.e. the fiber reinforced polymer material. The polymer material is described with an elastic-plastic material model. The plastic potential comprises not only the generally customary first invariant of the deviator of the stress tensor but also a polynomial theorem in the second and third invariants. The flow rule does not have an associated formulation. The potential likewise comprises not only the first invariant of the deviator but also terms of the second and third invariants. The viscosity is formulated by allowing the flow condition to be temporarily violated. The projection back onto the yield surface is time-dependent through a viscous term. For permanent loading, the solution is achieved numerically by iteration over correspondingly long times. The strength hypothesis for the polymer is based on failure surfaces that likewise comprise not only the first invariant but also the second and third invariants of the stress tensor. The strain rate dependence is incorporated in the failure description by way of weighting. The calibration of the parameters of the model is based on tension, shear and compression tests.

Elastically brittle behavior is assumed for the fiber material. Parameters here are the rigidity and the breaking stress of the fiber material.

The micromechanical model of the material composite is based on an homogenization process according to Mori-Tanaka, described in T. Mori and K. Tanaka, “Average stress in matrix and average elastic energy of materials with misfitting inclusions”, Acta Metallurgica, Vol. 21, May 1973, pages 571 to 574 and J.D. Eshelby, “The determination of the elastic field of an ellipsoidal inclusion, and related problems”, Proc. of the Royal Society of London, Series A, 1957, pages 376 to 396. Here, the contributions to the material behavior of the two phases, that is to say polymer and fibers, are numerically weighted with respect to one another. Considered here as parameters are the fiber content, the geometry and the orientation distribution density of the fibers.

The material law allows determination of the anisotropy through the fibers in the polymer, the nonlinearity and the strain rate dependence resulting from the polymer material, which leads to the known tension/compression asymmetry, and also the failure behavior. Failure occurs if the polymer matrix fails, the fibers break or the matrix becomes detached from the fibers. Moreover, the material law can be coupled in a simple way with a simulation for the process.

The calculation of the degree of utilization of the strength in step (b) takes place by a customary numerical method. Such numerical methods are generally finite difference methods, finite element methods and finite volume methods. A finite element method is preferably used for the calculation of the degree of utilization of the strength. To be able to carry out to the numerical calculation, it is necessary to describe the component by a grid network. For this purpose, the contour of the component is depicted in the form of a grid network. Customary grid networks that are used in finite element methods are triangular grids and rectangular grids. The mesh width of the grid, i.e. the spacing between two respectively joined points, is chosen such that a sufficiently accurate depiction of the component is possible by the grid network. Complex regions consequently require a smaller mesh width, while a greater mesh width is adequate in less complex regions. Since, for the strength calculation, it is not adequate just to model the surface of the component, but it is also necessary to model the internal regions, the entire component is depicted in the form of a spatial grid network.

To calculate the degree of utilization of the strength, the orientation of the fibers in the fiber reinforced plastic and the weld lines, determined in the first simulation calculation in step (a), are transferred to the grid network. Further variables that are required for the calculation of the degree of utilization of the strength are material variables of the plastic and of the fibers. In particular, relevant material variables are, for example, the modulus of elasticity, Poisson's ratio, parameters for the plastic potential, viscosity parameters and rupture strengths of the polymer, fiber geometry and delamination resistance as well as the modulus of elasticity, Poisson's ratio and tensile strength of the fibers. The pressure and temperature dependence of the individual material data must also be respectively taken into account here. From these variables, the strength-relevant characteristic values for the fiber reinforced polymer material are calculated by means of the micromechanical model for the description of the material composite.

Plastics that are used in the fiber reinforced polymer material are, in particular, thermoplastic polymers. Preferred plastics are, for example, polyamide (PA), polybutadiene terephthalate (PBT), polypropylene (PP), polyethylene (PE), polyether sulfone (PES) and polysulfone (PSU).

Fibers that are used, in particular, are glass fibers, carbon fibers or aramid fibers. Chopped fibers, i.e. fibers with a fiber length of less than 0.5 mm, preferably less than 0.4 mm, are generally used. However, fibers with a length of up to several millimeters, preferably with a length of up to 20 mm, can also be used.

The production process for the component is generally an injection molding process. The first simulation calculation, which is carried out to determine the orientation of the fibers in the fiber reinforced plastic and the weld lines in the component in step (a), is consequently a modeling of the injection molding process. For this purpose, generally the injection nozzle and the injection mold are depicted by a grid network. The injection operation of the polymer mass comprising fibers is described by the modeling. For this purpose, it is necessary to describe the entire injection operation during which polymer mass is injected into the mold. Apart from the three-dimensional local description of the mold, a time profile of the injection operation into the mold must also be described. The time profile of the injection process gives the orientation of the fibers over time in the polymer mass. At the same time, the position of the weld lines in the component is also described by this.

Further variables that are described by the modeling of the production process are, in particular, the pressure variation and the temperature variation. The pressure variation and the temperature variation are in this case represented both temporally and locationally.

Once the strength-relevant characteristic values for the fiber reinforced polymer material in the component have been determined from the material data, the orientation distribution density of the fibers and the position of the weld lines, it is possible to assess the degree of utilization of the strength. For this purpose, a strength simulation is carried out on the component.

The local loading on the component is used as a boundary condition for the strength simulation. To be able to determine the necessary strength that the component must have, here too it is necessary again to determine the time profile over a great period of time. In particular if the component serves as an engine support, dynamic loading, such as occurs for example as a result of engine vibrations, must also be taken into account here. The weak points of the component are determined by the strength simulation. For example, it shows at which point of the component bending or shearing occurs for example under given loading. If the damage to the component occurs under loading that is lower than the loading to which the component is exposed, it is necessary to increase the wall thickness at these points. At the same time, it is possible to choose a lower wall thickness at those points at which no failure of the component occurs. In this way, the wall thickness of the component can be adapted locally to the respective loading that occurs. This has the effect that material can be saved in the later production of the component by optimum design of the wall thickness, since it is not necessary for the entire component to be made with the maximum wall thickness. This leads to a weight saving, as is desired in particular in vehicle construction, since additional weight always means higher fuel consumption. Moreover, in this way the installation space for the component can optionally also be optimized.

The method according to the invention is suitable in particular for designing the wall thickness of engine supports in a motor vehicle. Apart from the static loading on account of the mass of the engine, the engine supports in a motor vehicle are also subjected to permanent dynamic loading due to vibrations that are emitted by the engine. Moreover, irregular loads occur during the driving of the motor vehicle. These are attributable for example to different speeds at which the vehicle is operated, road conditions and accelerating and braking operations. To design the wall thickness, these loads of the support must also be taken into account. The loads are used as a force boundary condition for resolving the model.

Components that can be designed by the method according to the invention are, for example, supports, such as engine supports in motor vehicle construction. Apart from design for engine supports, however, the method according to the invention is also suitable for example for designing transmission cross members, chassis mounts, rods, bars and supports. All other highly loaded components of fiber reinforced plastics, in particular of glass fiber reinforced polyamide, may also be designed by the method according to the invention.

The method according to the invention allows a component of a fiber reinforced polymer material that is permanently subjected to static and/or dynamic loading to be designed, the component having a wall thickness that is adapted to the local loading acting on the component.

An exemplary embodiment of the invention is represented in the drawings and is explained in more detail in the description which follows.

### IN THE DRAWINGS

FIG. 1 shows a three-dimensional representation of a pendulum support,

FIG. 2 shows a modeled fiber orientation in a pendulum support according to FIG. 1 with a first gating point,

FIG. 3 shows the distribution of the failure value in a pendulum support with a fiber distribution according to FIG. 2,

FIG. 4 shows a modeled fiber orientation in a pendulum support according to FIG. 1 with an alternative gating point,

FIG. 5 shows the distribution of the failure value in a pendulum support with a fiber orientation according to FIG. 4.

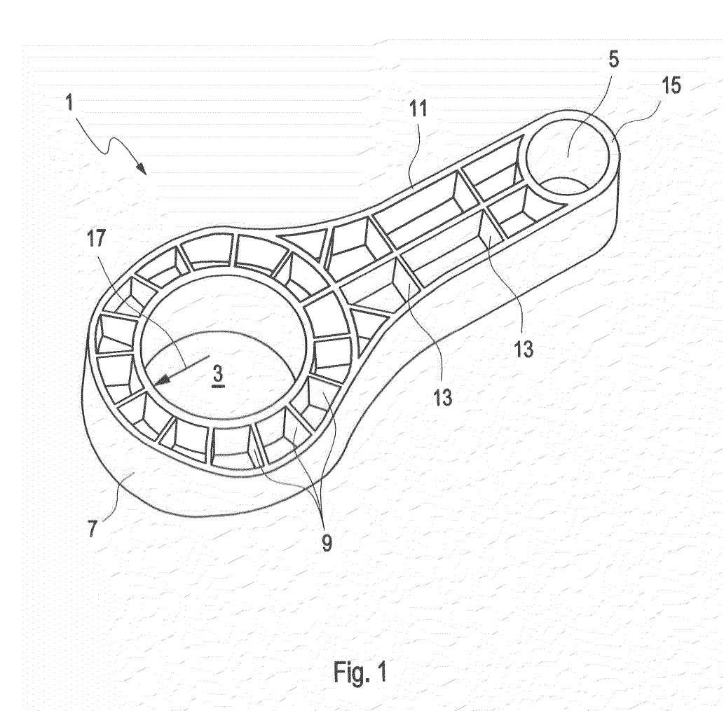

FIG. 1 shows a three-dimensional representation of a pendulum support such as that used for example in motor vehicle construction.

Usually, pendulum supports are produced from metal on account of the great forces acting on them. However, this has the disadvantage that the pendulum supports have a great mass. To lower the fuel consumption of a motor vehicle, however, it is desired to lower the mass of the motor vehicle. One possibility is to use materials with lower density, such as for example plastics. However, plastics generally have a lower strength than metals, so that in particular in the case of components that are subjected to high loading, it must be assumed that they will fail if plastics are used.

A pendulum support 1 has a first through-opening 3 and a second through-opening 5. The first through-opening 3 is enclosed by an annular structure 7. For stabilization, the annular structure has ribs 9. This allows the wall thickness of the annular structure 7 to be reduced, and consequently weight to be saved. The annular structure 7 is adjoined in the radial direction by a bar 11. In a way similar to the annular structure, the bar 11 is not made of a solid form but in the form of a double T structure which is reinforced with ribs 13. The second through-opening 5 is formed at the end of the bar 11. On account of the small dimension in this region, the second through-opening 5 is enclosed by a solid annular wall 15.

The pendulum support 1 is fixed by the second through-opening 5. During operation, a force 17 acts in the axial direction on the side of the first through-opening 3 that is opposite from the part 11. For the subsequent representations of the loading on the pendulum support 1, it is assumed that the force 17 has a magnitude of 30 kN.

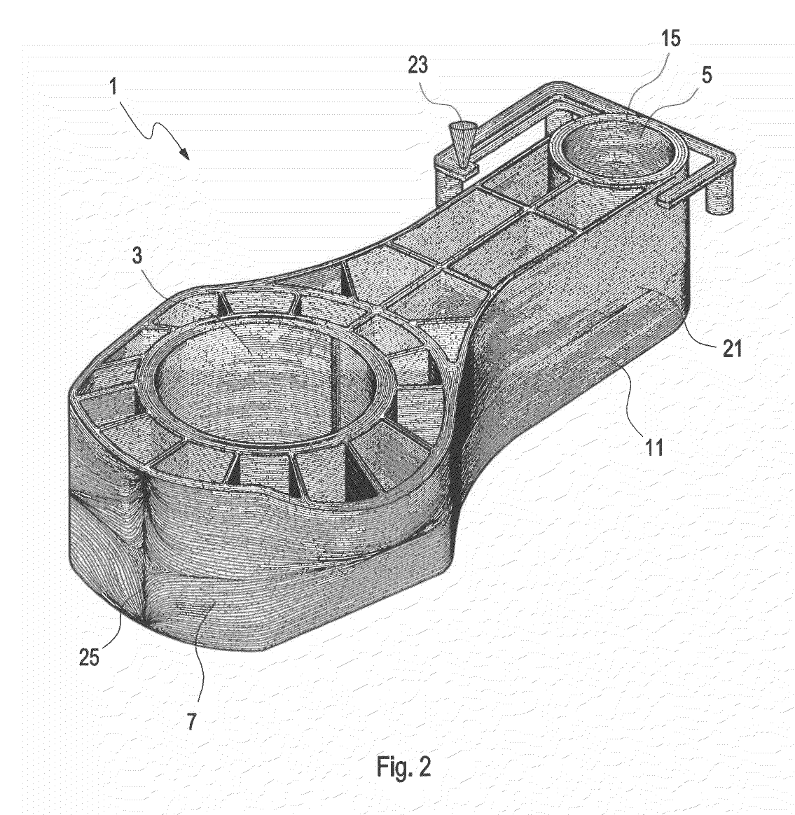

In FIG. 2, a fiber distribution in a pendulum support according to FIG. 1 is represented.

The pendulum support is injection-molded from a fiber reinforced plastic. Thermoplastics are suitable in particular as the plastic. Particularly preferred, for example, are polyamide (PA), polybutadiene terephthalate (PBT), polypropylene (PP), polyethylene (PE), polyether sulfone (PES) and polysulfone (PSU).

Glass fibers, carbon fibers or aramid fibers are used in particular as fibers. In general, chopped fibers, i.e. fibers with a fiber length of less than 0.5 mm, preferably less than 0.4 mm, are used. However, fibers with a length of up to several millimeters, preferably with a length of up to 20 mm, may also be used.

The following calculations of the failure value are carried out for a polyamide PA66 as the plastic, which is reinforced with glass fibers with an average fiber length of 0.3 mm (Ultramid® A3WG10CR of BASF AG).

In FIG. 2 it can be seen that the fibers 21 are oriented parallel to the direction of flow from the gating point 23. As a result, orientation of the fibers along the direction of loading of the pendulum support 1 is achieved. The only exception is the weld line 25. The weld line 25 is the region in which the polymer melt that flows around the first through-opening 3 on both sides during the injection process flows together again. This leads to an axial orientation of the fibers in the region of the weld line 25. A potential weak point is created.

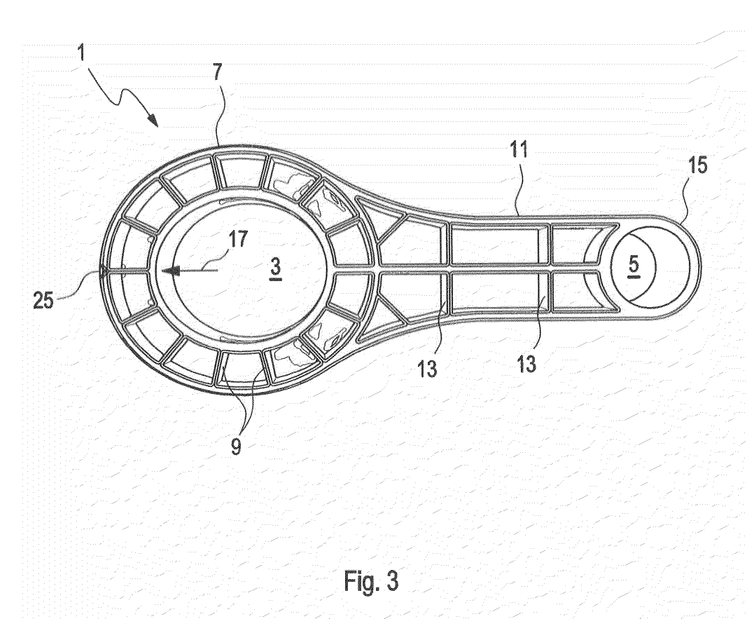

FIG. 3 shows the failure values for a pendulum support 1 with a fiber distribution according to FIG. 2. The greatest stresses act on the pendulum support 1 in the region in which the bar 11 branches away from the annular structure 7. However, the material of the pendulum support 1 is stabilized by the orientation of the fibers 21 in this region, so that their failure is to be expected in the region in which the bar 11 branches away from the annular structure 7. However, on account of their orientation in the region of the weld line 25, the fibers 21 do not contribute to the stabilization of the annular structure 7. The stress that acts on the weld line 25 on account of the force 17 acting on the inner side of the first through-opening 3 leads to a failure value of 1.755. This is enough to lead to a rupture of the pendulum support 1 in the region of the weld line 25.

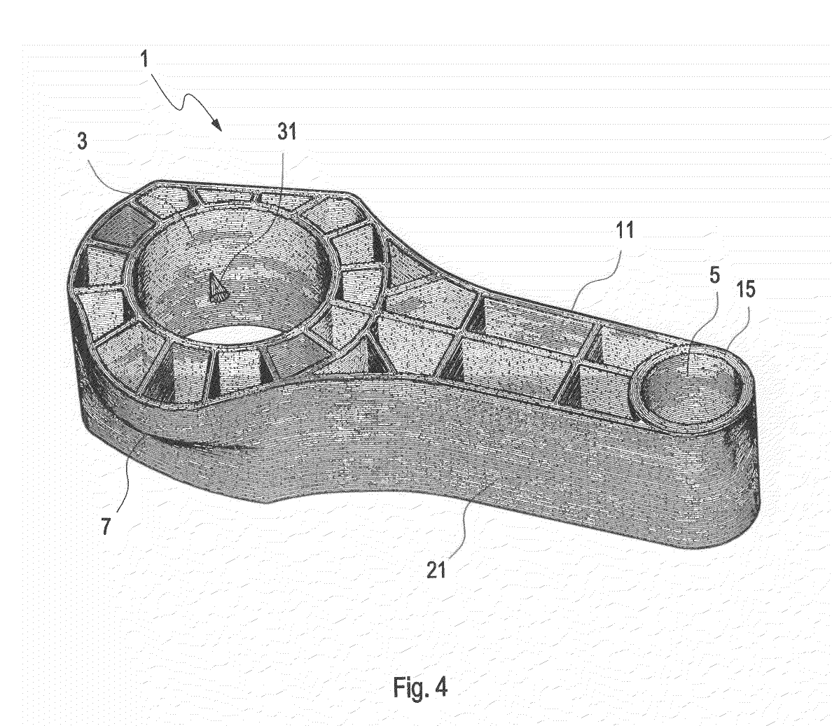

In FIG. 4, a fiber distribution in a pendulum support with an alternative gating point is represented.

In the case of the fiber distribution represented in FIG. 4, the gating point 31 is arranged in the region of the first through-opening. This has the effect that the fibers in the region of the annular structure 7 that lie opposite the bar 11 and in which the weld line 25 is formed in the embodiment represented in FIG. 2, are oriented in a tangential direction. This orientation leads to a stabilization of the annular structure 7 in this region.

On account of the arrangement of the gating point 31, the weld line in the region of the second through-opening 5 is located on the side opposite from the bar 11. Since, however, on account of the fixing of the pendulum support 1 in the second through-opening 5, the stress acting there is lower than the stress that acts on the first through-opening 3, no forces occur with a magnitude that would make the failure value greater than 1 and cause failure, that is to say rupture, of the pendulum support in this region.

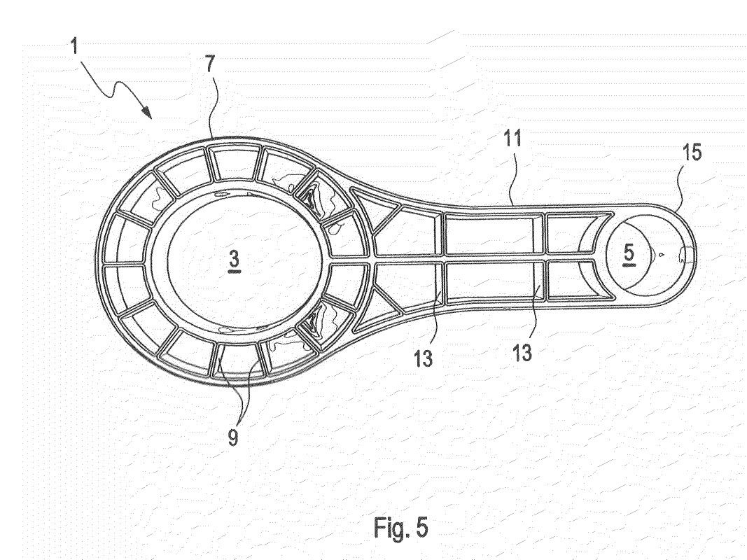

With constant loading on the annular structure, in this case, as represented in FIG. 5, the failure value is less than 1 throughout the annular structure 7, so that no failure of the pendulum support occurs.

Consequently, with the method according to the invention it is possible to find a geometry with which even a pendulum support made of a plastic has sufficient stability.

Apart from the pendulum support represented here, the method according to the invention can, however, also be applied to any desired other support and to all other highly loaded components of fiber reinforced plastics, in particular of glass fiber reinforced polyamide.

### LIST OF DESIGNATIONS

1 pendulum support

3 first through-opening

5 second through-opening

7 annular structure

9 ribs

11 bar

13 ribs

15 annular wall

17 force

21 fibers

23 gating point

25 weld line

31 gating point

1. A method for designing the wall thickness of components that are permanently subjected to static and/or dynamic loading, the components being made of a fiber reinforced polymer material, comprising the following steps:
a. determining the orientation of the fibers in the fiber reinforced plastic and of the weld lines in the component by a first simulation calculation,
b. calculating a degree of utilization of the strength of the component by a second simulation calculation,
c. adapting the component geometry and/or the position of the at least one gating point of the component to the result of the second simulation calculation, a reduction of the wall thickness taking place if the degree of utilization exceeds a predetermined upper limit value and an increase of the wall thickness taking place if the degree of utilization falls below a predetermined lower limit value,
d. repeating steps (a) to (c) if a change of the component geometry and/or of the position of the at least one gating point has been carried out in step (c).

2. The method according to claim 1, wherein, to determine the orientation of the fibers and the weld lines in step (a), the production process of the component is simulated.

3. The method according to claim 1 or 2, wherein, for the calculation of the degree of utilization of the strength in step (b), the contour of the component is depicted in the form of a grid network.

4. The method according to claim 3, wherein the values for the fiber orientation and the weld lines determined in step (a) are transferred to the grid network for the calculation of the degree of utilization.

5. The method according to claim 4, wherein strength-relevant characteristic values are determined from the values for the fiber orientation and the weld lines that are transferred to the grid network for the calculation of the degree of utilization.

6. The method according to one of claims 1 to 5, wherein the production process for the component is an injection molding process.

7. The method according to one of claims 1 to 6, wherein the fiber reinforced plastic comprises a matrix of a polymer material, selected from the group comprising polyamide, polybutylene terephthalate, polypropylene, polyethylene, polyether sulfone and polysulfone, and glass fibers, carbon fibers or aramid fibers in the latter.

8. The method according to claim 7, wherein the fibers have a length of less than 0.5 mm.

9. The method according to claim 7 or 8, wherein the fibers are randomly disposed in the matrix.

10. The method according to one of claims 1 to 9, wherein the component is an engine support in a motor vehicle, a transmission cross member, a chassis mount or a rod, bar or support.

11. A component of a reinforced polymer material that is permanently subjected to static and/or dynamic loading, the component having a wall thickness that is adapted to the local loading acting on the component by a method according to one of claims 1 to 10.
